(19) United States
(12) Patent Application Publication
(10) Pub. No.: US 2002/0111930 A1
(43) Pub. Date: Aug. 15, 2002

(54) Device and process for high-throughput assembly of artificial chromosomes and genomes

(76) Inventor: John A. Battles, Waltham, MA (US)

Correspondence Address: CAMPBELL & FLORES LLP, 4370 LA JOLLA VILLAGE DRIVE, 7TH FLOOR, SAN DIEGO, CA, 92122, US

(21) Appl. No.: 09/851,600

(22) Filed: May 8, 2001

Related U.S. Application Data
(60) Provisional application No. 60/216,248, filed on Jul. 6, 2000.

(51) Int. Cl. G06F 7/00

(52) U.S. Cl. 707/1

(57) ABSTRACT

The present invention is a computerized system for managing the finishing of a complete genome, or fragment thereof or a related derivative thereof, having a PrimerEngine component operative to identify combinations of primers and templates according to suitability for gap closure, quality enhancement or coverage; a Project Manager component operative to identify projects, users, and sequencing data sources; an Assembly module operative by reassembling nucleic acid sequences into artificial chromosomes or genomes; a Data Visualization Module operative to provide information about reads, and contigs; a Report module operative to provide information about a project; an Order module operative to provide information about the status of an order or sequence-reaction; and a Project Administration component operative to create projects and to assign user access to the projects, methods of use thereof.

### CROSS-REFERENCE TO RELATED APPLICATIONS

This section is not applicable to the present application.

### STATEMENT REGARDING FEDERALLY SPONSORED RESEARCH OR DEVELOPMENT

This section is not applicable to the present application.

### FIELD OF THE INVENTION

The field of the present invention is sequence assembly processes.

### BACKGROUND OF THE INVENTION

One of the major challenges associated with the Human Genome Project, or indeed, any sequencing project is the management of the vast amounts of data that are generated.

### BRIEF SUMMARY OF THE INVENTION

The present invention is a computerized system for managing the finishing of a complete genome, or fragment thereof or a related derivative thereof, having a PrimerEngine component useful for identifying combinations of primers and templates according to suitability for gap closure, quality enhancement or coverage; a Project Manager component useful for identifying projects, users, and sequencing data sources; an Assembly module useful for reassembling nucleic acid sequences into artificial chromosomes or genomes; a Data Visualization Module useful for providing information about reads, and contigs; a Report module useful for providing information about a project; an Order module useful for providing information about the status of an order or sequence-reaction; and a Project Administration component useful for creating projects and to assign user access to the projects, methods of use thereof.

### BRIEF DESCRIPTION OF THE DRAWING

FIG. 1 is a functional block diagram depicting the modules of the present invention, and their connections to each other and external processes.

FIGS. 2A and 2B are functional block diagrams depicting sub-processes and data structures that are evoked from the Data Manager Module.

FIG. 3 is a functional block diagram depicting sub-processes and data structures that are evoked from the Assembly Module.

FIG. 4 is a functional block diagram depicting sub-processes and data structures that are evoked from the Data Visualization Module.

FIG. 5 is a functional block diagram depicting sub-processes and data structures that are evoked from the Reports Module.

FIG. 6 is a functional block diagram depicting sub-processes and data structures that are evoked from the PrimerEngine.

FIG. 7A and 7B are functional block diagrams that depict sub-processes and data structures that are evoked from the Order Manager.

FIG. 8 is a functional block diagram depicting the connections between certain process modules and data structures of the present invention when the invention is used to process base sequence information in Assemblies.

FIG. 9 is a block diagram depicting a graphical user interface for the present invention.

FIG. 10 is a flow diagram depicting the Assembly process.

### DETAILED DESCRIPTION OF THE INVENTION

The present invention provides a computerized method for managing the finishing of a complete genome, or a fragment thereof or a related derivative thereof that includes:

maintaining a PrimerEngine component for identifying combinations of primers and templates according to suitability for gap closure, quality enhancement or coverage;

maintaining a Project Manager component to identify projects, users and sequence data sources;

controlling an Assembly module to reassemble nucleic acid sequences into artificial chromosomes or genomes; and

accessing a Project Administration component to create projects and to assign user access to the projects.

Another aspect of the present invention provides the additional process of accessing a Data Visualization Module to provide information about reads, and contigs.

Another aspect of the present invention provides the additional process of accessing a Report module to provide information about a project.

Another aspect of the present invention provides the additional process of accessing an Order module to provide information about the status of an order or sequence-reaction.

Another aspect of the present invention provides a computerized method for managing the finishing of a complete genome, or fragment thereof or a related derivative thereof, that includes:

maintaining a PrimerEngine component for identifying combinations of primers and templates according to suitability for gap closure, quality enhancement or coverage;

maintaining a Project Manager component to identify projects, users and sequence data sources;

controlling an Assembly module to reassemble nucleic acid sequences into artificial chromosomes or genomes;

accessing a Project Administration component to create projects and to assign user access to the projects;

accessing a Data Visualization Module to provide information about reads, and contigs;

accessing a Report module to provide information about a project; and

accessing an Order module to provide information about the status of an order or sequence-reaction.

The present invention provides a computerized system for managing the finishing of a complete genome, or fragment thereof or a related derivative thereof that includes:

a primer template database component useful for identifying combinations of primers and templates according to suitability for gap closure, quality enhancement or coverage.

Another aspect of the present invention provides a computerized system for managing the finishing of a complete genome, or fragment thereof or a related derivative thereof that includes:

a PrimerEngine component useful for identifying combinations of primers and templates according to suitability for gap closure, quality enhancement or coverage; and

a Project Manager component useful for identifying projects, users, and sequencing data sources.

Yet another aspect of the present invention provides a computerized system for managing the finishing of a complete genome, or fragment thereof or a related derivative thereof that includes:

a PrimerEngine component useful for identifying combinations of primers and templates according to suitability for gap closure, quality enhancement or coverage;

a Project Manager component useful for identifying projects, users, and sequencing data sources; and

an Assembly module useful for reassembling nucleic acid sequences into artificial chromosomes or genomes.

Another aspect of the present invention provides a computerized system for managing the finishing of a complete genome, or fragment thereof or a related derivative thereof that includes:

a PrimerEngine component useful for identifying combinations of primers and templates according to suitability for gap closure, quality enhancement or coverage;

a Project Manager component useful for identifying projects, users, and sequencing data sources;

an Assembly module useful for reassembling nucleic acid sequences into artificial chromosomes or genomes; and

a Data Visualization Module useful for providing information about reads, and contigs.

Another aspect of the present invention provides a computerized system for managing the finishing of a complete genome, or fragment thereof or a related derivative thereof that includes:

a PrimerEngine component useful for identifying combinations of primers and templates according to suitability for gap closure, quality enhancement or coverage;

a Project Manager component useful for identifying projects, users, and sequencing data sources;

an Assembly module useful for reassembling nucleic acid sequences into artificial chromosomes or genomes;

a Data Visualization Module useful for providing information about reads, and contigs; and

a Report module useful for providing information about a project.

Another aspect of the present invention provides a computerized system for managing the finishing of a complete genome, or fragment thereof or a related derivative thereof that includes:

a PrimerEngine component useful for identifying combinations of primers and templates according to suitability for gap closure, quality enhancement or coverage;

a Project Manager component useful for identifying projects, users, and sequencing data sources;

an Assembly module useful for reassembling nucleic acid sequences into artificial chromosomes or genomes;

a Data Visualization Module useful for providing information about reads, and contigs;

a Report module useful for providing information about a project; and

an Order module useful for providing information about the status of an order or sequence-reaction.

Still another aspect of the present invention provides a computerized system for managing the finishing of a complete genome, or fragment thereof or a related derivative thereof that includes:

a PrimerEngine component useful for identifying combinations of primers and templates according to suitability for gap closure, quality enhancement or coverage;

a Project Manager component useful for identifying projects, users, and sequencing data sources;

an Assembly module useful for reassembling nucleic acid sequences into artificial chromosomes or genomes;

a Data Visualization Module useful for providing information about reads, and contigs;

a Report module useful for providing information about a project;

an Order module useful for providing information about the status of an order or sequence-reaction; and

a Project Administration component useful for creating projects and for assigning user access to the projects.

Definitions

As used herein the term “artificial chromosome” refers to the nucleic acid sequence of a chromosome that is constructed from a series of smaller nucleic acid sequences.

As used herein the term “contig” refers to a contiguous consensus nucleotide sequence. A contig could comprise one sequence.

As used herein the term “coverage” is determined by the number of sequences or reads at any individual base position.

As used herein the term “finishing” refers to the processes whereby nucleic acid sequences are reassembled into artificial chromosomes or genomes, such as, bacterial artificial chromosomes (BACS), or yeast artificial chromosomes, and the like.

As used herein the term “finishing project” refers to a list of users and sequencing data sources.

As used herein the term “gap” refers to instances where there are missing nucleic acids in a contig.

As used herein the term “gap mode” refers to an activity of present invention where primers are selected that extend the contig consensus into the gaps at either end of the contig.

As used herein, the terms “improvement target” refers to region in an assembly where the base sequence information is inadequate or deficient. For example, the region could contain a gap, that is, a series of unknown bases; the region where the base could contain base sequence information that is of low quality, which a user could select as the minimum acceptable threshold.

As used herein, the term “PrimerEngine” refers to a primer/template database that facilitates an assembly process by optimizing the selection of primers to be used in an assembly process according to the specific needs, such as, gap closures, quality enhancement or sequence coverage for a given contig or an entire assembly.

As used herein the term “quality” refers to the likelihood that the predicted base is the correct base.

As used herein, the term “quality enhancement” refers to the process of improving the quality of specific regions. For example, an improvement target could be regions where there is a gap in the base sequence; where the base sequence information is of low quality; where there is only single stranded information.

As used herein the term “reads” refers to the base sequence information of a fragment of nucleic acids that has been sequenced by any process, such as, the Sanger dideoxy method or the use of DNA polymerase enzymes.

As used herein the term “related derivative thereor” refers to a sequence of nucleic acids which depart from the structure of the naturally occurring sequence, but which have substantially the structure of the naturally occurring sequence, such that they can be substituted within the genome which retains its functionality.

The application is accessed by a user through a graphic interface. The interface includes zones, graphically represented as, buttons, lists, drop-down lists, panes, panels, scroll bars, split bars, tabs, tables, text boxes, and the like, where the user can make program calls to instruct the modules to perform an activity, or to view data regarding a module or application. The interface has a first portion 901 from which a user can initiate a program call to any of the modules of the application, such as, Program Administration 901.1, Program Manager 901.2, Assembly Module 901.3, PrimerEngine 901.4, Order Manager 901.5, Data Visualization Module 901.6, or Report Module 901.7. A second portion 902 of the interface is where a user can initiate a program call to any sub-module associated with a module of the application. A third portion 903 of the interface provides the user with graphical or textual information specific for the module that has been selected. A fourth portion 904 of the interface is where a user can select options for the module. A fifth portion 905 of the interface is where a user can issue program calls for functions that are not specific to a module, such as, a next window function 905.1, access to online help 905.2, a print function 905.3, a refresh the display function 905.4, and the like.

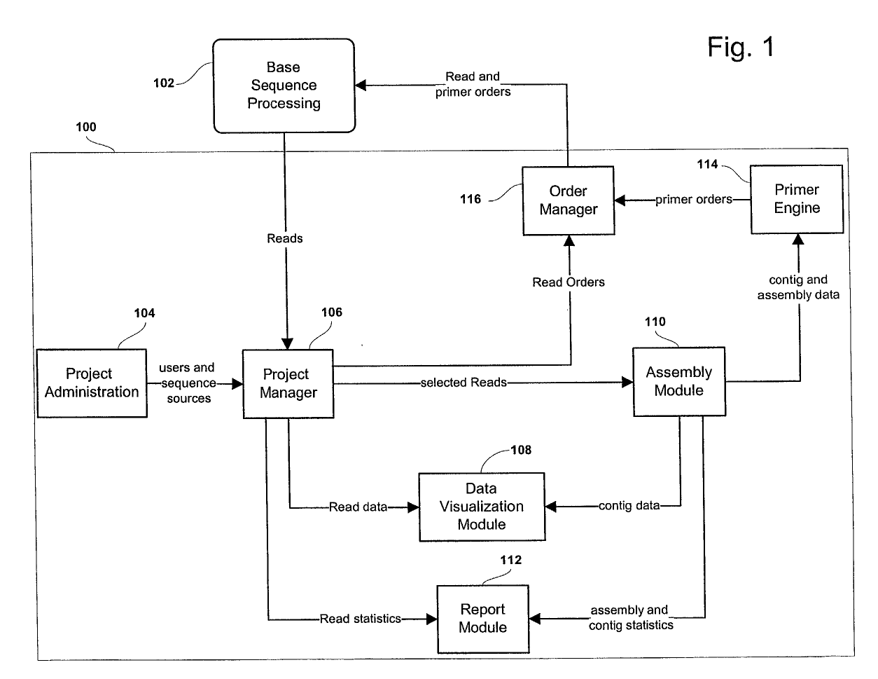

FIG. 1 depicts the interconnections between modules of the application, as well as connections with external process. 100 defines the processes and data structures of the present invention. 102 represents a base sequencing processing that returns base sequence information pertaining to fragments of nucleic acid sequences. The origin of nucleic acid sequences can be from any type of organism. The Project Administration module 104 enables a user to create and to create projects and to assign user access to the projects. By default, a user that creates a project is defined as the creator of the project. In 104 the creator of a project can add or remove users from the project, as well as, sequence data sources. Sequence data sources are collections of sequencing reads. The creator can also change the security level of a user. The application designates two types of users, Owners and Viewers. Owners have the ability to delete the project, or to change the application's operation state by initiating processes such as running assemblies, or picking primers, thereby changing the state of a project. Viewers do not have the ability to initiate processes. Viewers are only permitted to view data and reports. By default the creator of a project is an Owner. A project can have multiple owners. The Project Manager 106 module is a graphical interface from which an Owner can manage Reads that are being provided to the application from Base Sequencing Processing. Through 106 a user can export data, such as, reads, contigs, or assembly files on demand. Read and contigs can be selectively exported as sequence data, quality data or both. Assembly files are exported in the “ace” file format, which is a new widely accepted file format for assembly files. The Data Visualization Module 108 provides tools for graphically viewing the data in the Finishing Workbench. For example, a read viewer, a read alignment viewer, and a contig viewer. The Assembly Module 110 runs the assembly process, which includes, generating assembly statistics, and loading the resulting data into an application database. Owners are able to start, monitor, and stop the application process and can set version, and parameter specifications on a project basis. The Assembly Module can be manually initiated from the module's graphical interface, or alternatively, can be programed automatically run whenever a new read is received. Running an assembly changes the state of a project and results in the creation of contigs and the updating of read, contig and assembly statistics. The Report Module 112 generates reports relating to various aspects of a project that a user can access, such as, Read data, contig data and assembly data. The Primer Engine 114 facilitates an assembly process by optimizing the selection of primers to be used in an assembly process according to the specific needs, such as, gap closures, quality enhancement or sequence coverage for a given contig or an entire assembly. The Order Manager 116 provides an Owner the ability to track and monitor information pertaining to the status of any given order, or sequencing-reaction. The Order Manager monitors the elements of sequence reaction, such as, templates, primers, plates, and wells, along with reaction attributes such as, chemistry, and reaction type, for example, PCR/shotgun/‘finishing’ primer-walk. Order Manager also manages auxiliary information about each order and each reaction, such as, the identify of the user requesting the order, the project for which the order was submitted, and various clerical information, such as, accounting, charge number, and invoicing information. In the process of creating an order, the Order Manager forwards appropriate information to related systems or entities. The Project Administration Module 104, Project Manager 106 and Data Visualization Module 108 provides the user with the ability to monitor the status of a project. Assembly processing involves the Order Manager 116, the Assembly Module 110, the Report Module 112 and the Primer Engine 114.

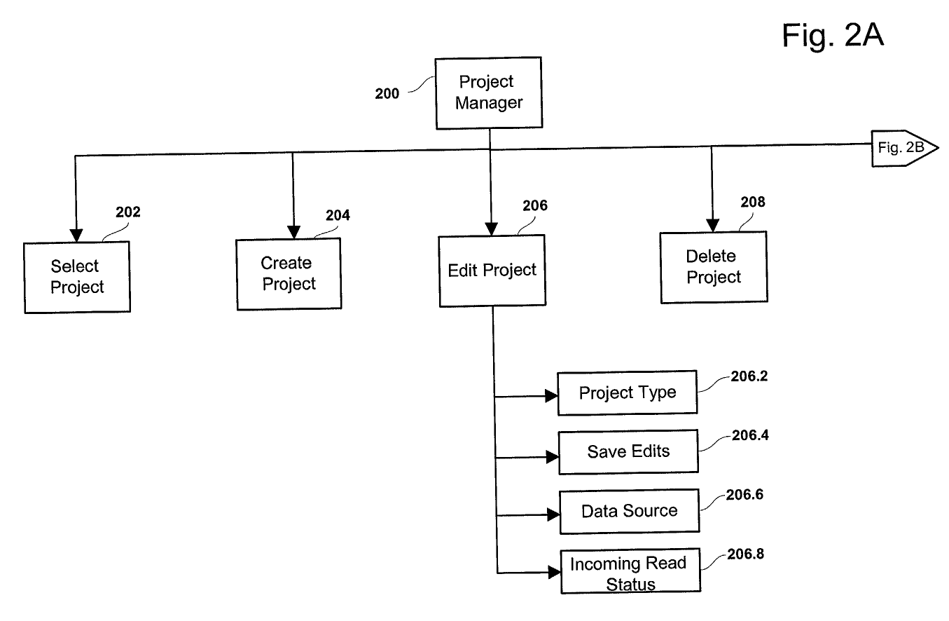

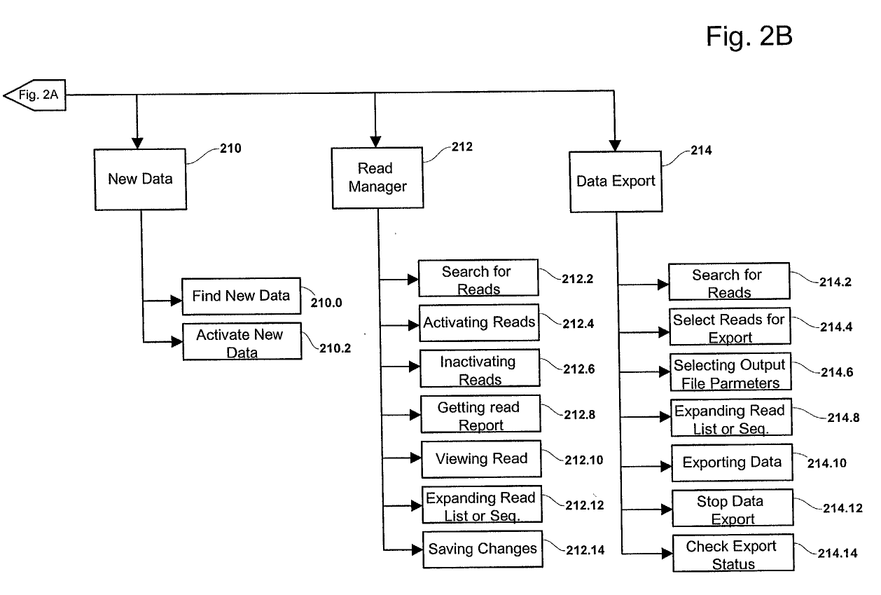

The Project Manager component 200 is depicted in FIGS. 2A and 2B. It comprised of sub-components that provide project management utilities to the user. The Select Project sub-component 202 is accessed by the user to select a desired project according to a project criteria, such as, project type, name, or owner. Once a desired project criteria is has been selected, a search function is initiated. The search function identifies all projects managed by the application, and provides this information to the user. This information is typically displayed in the third portion of the graphic interface. The Create Project sub-component 204 is accessed by the user to create a new project. The user provides a unique name for the project. The Edit Project sub-component 206 is accessed by the user to modify attributes of the project, such as, the project type 206.2, incoming read status 206.8, and the list of data sources associated with the project 206.6, that is, adding or removing data sources. The module also provides a Save Edits 206.4 feature that enables the user to control when edits are finalized by the application. The Delete Project sub-component 208 is accessed by the Owner of a project to delete the project. Information regarding the project is displayed, and a confirmation step is required before the project is deleted. The New Data sub-component 210 enables the user to retrieve reads 210.2 directly from the Base Sequence Processing Module. The data is retrieved according to a time period set by the user. The user enters a start date and an end date. The sub-component retrieves all previously unseen samples from all of the data sources associated with the project that had been collected during the set period and displays it through the Graphical Interface. The user has the option to activate any of this data 210.4, that is, to have this data included in an assembly process. Reads are selected by a Search sub-component 212.2. The user enters the attribute of the read(s) such as, the name or status of the read(s), and initiates a search. The sub-component displays all the reads that meet the search requirements. From this display, the user can activate 212.4 or inactivate 212.6 a read. The user can also obtain information about various aspects about a read. The user can obtain a report about the read 212.8, or the user can view 212.10 the read. The sub-component also provides options that facilitates the users management of the read data. The user can expand the display size of the read list 212.12 and the user can save 212.14 any changes made to the status of a read(s). The Data Export sub-component 214 enables the user to export projects, contigs, or “Ace” files from the Application to a file system. Reads are selected with the Search sub-component 214.2 according to name or variations of a common name where a “wildcard” character is used to designate that portion of the name that is varied. The Search can be initiated after the search criteria has been entered. The results of the search are displayed to the user by the Graphical Interface. The user selects the Read(s) 214.4 for export from the interface. There are several options provided for the selection of read(s). All reads can be selected or unselected. Alternatively, individual reads can be selected or unselected. The Output File Parameters sub-component 214.6 enables the user to select the new files to create, the file format, and file name for the files that are to be exported. The display of the read(s) or sequences of a read can be expanded 214.8 by the user. The sub-component enables the user to proceed with the export of the selected information 214.10. The user can also monitor the progress of the function by checking the export status 214.14, and if necessary can stop the process 214.12.

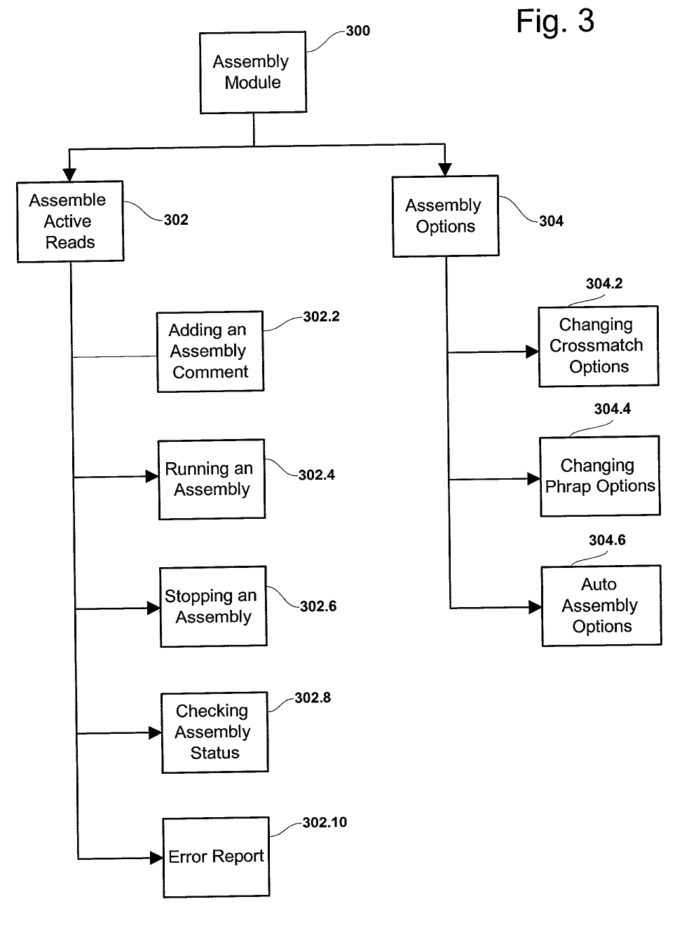

The Assembly module 300 is depicted in FIG. 3. The Assembly Module runs the assembly process, which includes, generating assembly statistics, and loading the resulting data into the application database. Owners are able to start, monitor, and stop the Finishing Workbench process and can set version, and parameter specifications on a project basis. The Assembly Module can be manually initiated from the module's graphical interface, or can be instructed to automatically run whenever a new read is received. Running an assembly changes the state of a project and results in the creation of contigs and the updating of read, contig and assembly statistics. At the Assemble Active Reads interface 302 the user can start an Assembly 302.4, the sub-component provides the user with a confirmation that the assembly has started. Through this sub-component the user can also perform a number of monitor and maintenance tasks. For example, the user can provide annotation regarding the assembly by adding an assembly comment 302.2. The user can also check on the status of an ongoing assembly 302.8, stop an assembly 302.6, or request an error report 302.10 that could be used for trouble-shooting errors encountered in an assembly. In the Assembly Options 304 interface, the user can set program options for “phrap” 304.4 and “cross-match” 304.2 or instruction the application to create a new assembly automatically new data arrives 304.6.

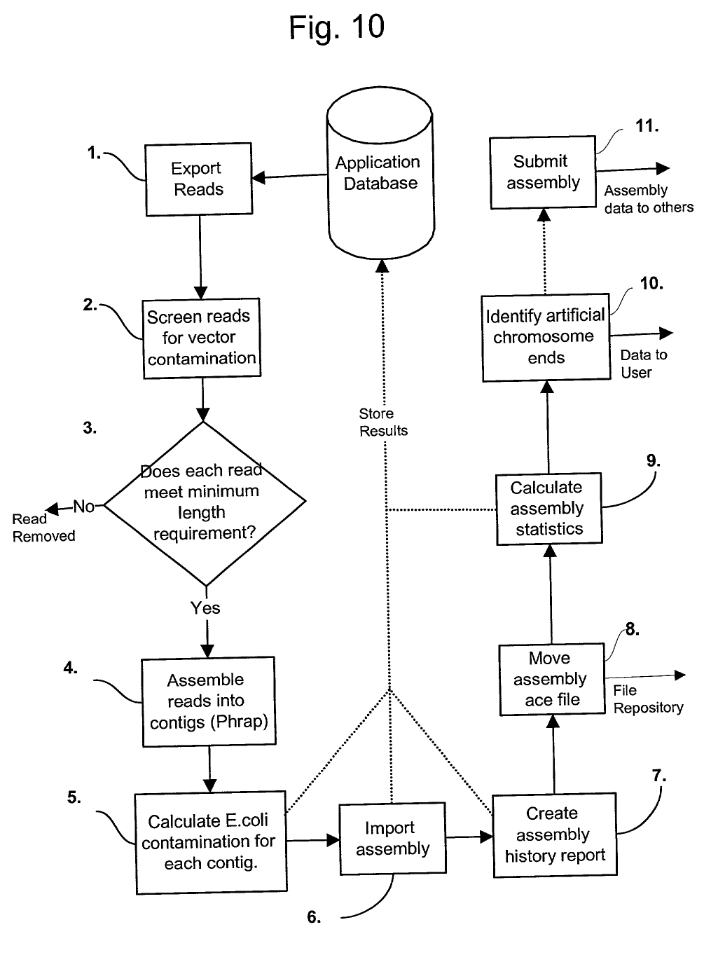

The Assembly process is graphically depicted in FIG. 10. When initiated the process submits a series of jobs that are executed by the application. A “run Assembly” job causes the server to create a temporary work directory and a list of jobs is submitted. A “dataExport” job exports active reads in fasta format from the Application Database. The “crossmatch” job screens for a vector. Assemblies that will be submitted to an other entity, such as, the NIH, need to be screened against a vector file with no artificial chromosome end vector data. The “seqMinLengthWeeder” job causes each sequence's total non-vector base count to be compared with the minimum sequence length. If the base count is less or equal to the minimum sequence length, the sequence is not assembled. The “phrap” job assembles the sequences into contigs. The “artifact” job screens contigs for contamination, for example when assemblying bacterial artificial chromosome, this job screens for E. coli contamination. The “assemblyHistory” job records Assembly History information, such as, project data sources and lists of active reads, to the Application database. The “aceimport” job sends assembly structure and contig information to the Application database. The “storeAcefile” job store the ace file in a file repository. The “assemblyStats” job generates statistics from assembly information and sends the statistics to the Application database. The “bacends” job calculates which contigs contain the bacends, and e-mails this information to the user. The “submission” job submits assembly information to a designated third party. The “cleanup” job cleans up the working directory of extraneous and temporary files.

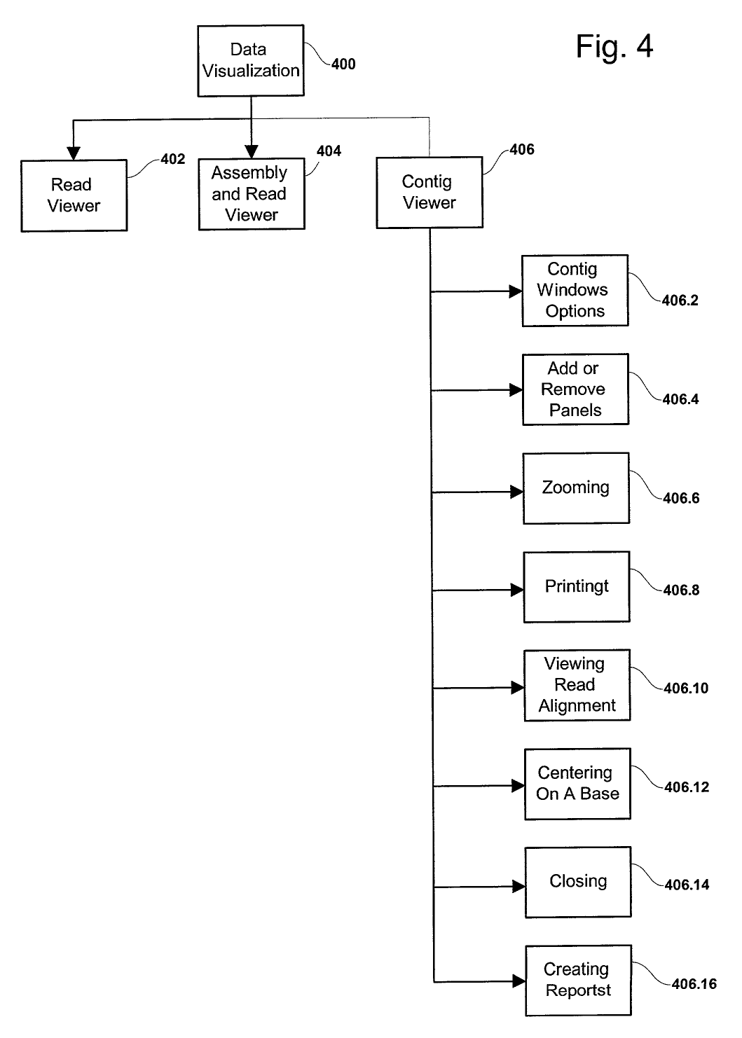

The Data Visualization module 400 is depicted in FIG. 4. The graphic interface of this module enables the user to access the Read Viewer 402, the Assembly and Read Viewer 404 and the Contig Viewer 406. The Read Viewer 402 enables the user to select and view the base sequence and quality of a read. The Assembly and Read Viewer 404 enables the user to select and view the base sequence and quality of reads which overlap in a given assembly. The Contig Viewer 406 enables the user to select, and view data associated with a selected contig. The user can call Contig Windows Options 406.2 that creates panels specific for reviewing the contigs by consensus, internal mates, missing mates, external mates, singleton mates, and single stranded regions. Panels 406.4 can be added or removed, as desired. In addition, the user can enlarge or zoom in on a particular panel 406.6, print a panel 406.8, view the read alignment 406.10, center the panel on a base 406.12, create a report 406.16 and close the panel 406.14.

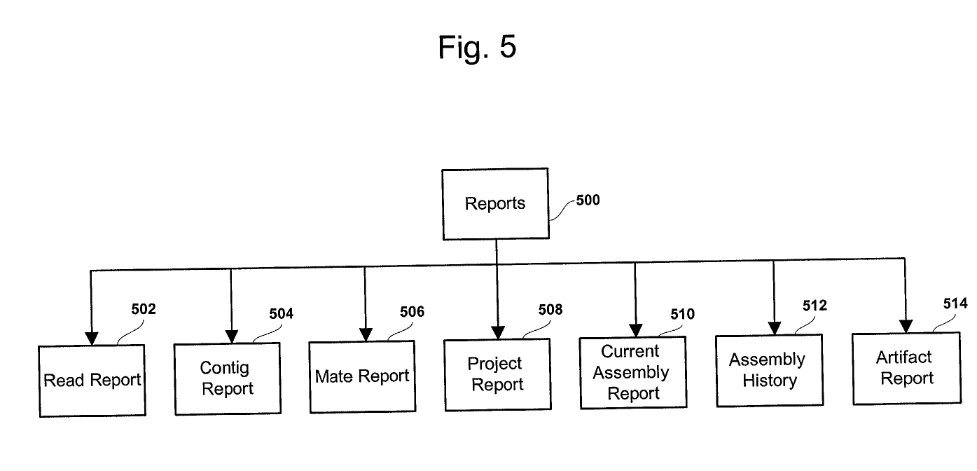

The Report module 500 is depicted in FIG. 5. This module enables a user to view various types of information about a selected project in the format of a report relating to a certain aspect of the project. The requested information is displayed in the interface and from this interface the user can have the information printed, or can close the display. A Read report 502 provides the name of the read; padded and unpadded length; average, minimum, and maximum phrap quality; and the contig with which the read is associated. A Contig report 504 provides the name of the contig; padded and unpadded contig length; number of reads; average, minimum, and maximum phrap quality scores; average, minimum, and maximum base coverage; total AGCT bases; percentage AGCT bases; total GC bases; total vector bases; percentage vector bases; total gap (“pad”) bases; percentage of gap (“pad”) bases; the number and percentage of bases with quality ranked in ten percentile increments; error rate per base; and the number of single stranded regions. A Mate report 506 provides a list of all the reads in a contig with various information relating to their mates. For Internal mates, the following information is provided, forward read name, reverse read name, and distance status. For External mates, forward read name, forward contig name, reverse read name, reverse contig name, and distance and orientation status. For Missing mates, direction and read name. A Project report 508 provides a list of data sources for the project including, a list of the data sources for the project with the percentage amount artifact for each data source; the average of the amount artifact of the data sources; the number of active, inactive, and duplicated reads; the number of attempted, successful, failed, and forced failed assemblies; and the number of primer and clone reads. A Current Assembly report 510 provides the name of the assembly; a list of data sources for the project with the percentage amount artifact of each data source; the number of contigs in the assembly; the number of missing mates; the number of mates in “violation,” that is, where they are too close, too far, or have the wrong orientation; the number of external mates; the number of new reads assembled as compared to the previous assembly; the number of gaps; the average base coverage, that is, the average of the number of reads covering each base; the average of the assembly is calculated by the following formula,

$$\frac{( 1 - percent artifact ) * ( no . of HQ bases )}{( length - no . vector bases )}$$

and the average amount of artifact for all of the data sources. An Assembly History 512 provides a list of the assemblies that have been done on a project. Selecting a desired assembly retrieves archived copies information that was previously available from the Current Assembly report. The Artifact report 514 provides a list of the current contigs with the percentage amount of artifacts for each. From this report, the user can access the Contig report 504 and contig display for each contig, and activate or de-activate the reads for each contig.

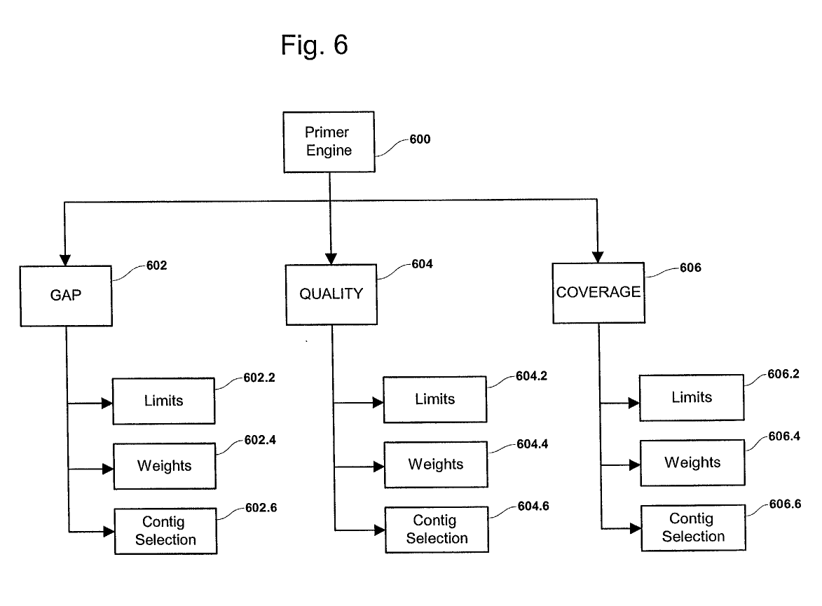

The PrimerEngine module 600 is depicted in FIG. 6. PrimerEngine enables the user to select primer-template combinations in one of three modes that correspond to typical objectives of an assembly. The Gap mode 602 selects primers that extend from the contig consensus into the gaps at either end of the contig. For each contig, PrimerEngine selects primers to read into both left and right end gaps. The user can enter parameters for the selection process. The Quality mode 604 scans the contigs to identify low quality targets. Primers are selected that generate reads to cover the target. The Coverage mode 606 scans the contigs to identify single stranded coverage target. Primers are selected that generate reads to provide double stranded coverage.

In the instance where there is no template that would extend into the target sequence, PrimerEngine would not be able to create a primer and template combination, and no primer is selected. Primers can be selected for specific contigs in a project, or for all the contigs.

Selection of primers for the best combination of primer and template is done according to a scoring function based on three components, 1) the primer specific terms, 2) the template specific terms, and 3) the primer-template interaction terms.

Primer specific terms are based on properties of the primer, such as, Tm, hairpins and the like. Template specific terms are based on properties of the template, such as templates that have valid external mates, or external templates that have a confirming mate pair, and the like. Primer-template interaction terms are based on each combination of a primer with a template, such as, uniqueness of a primer with a specific template, or uniqueness of a primer within all contigs of a project.

PrimerEngine returns a selection of primer-template pairs, such as, the top ten ranked according to score. This process provides greater efficiency to the user by generating a number of optional choices for a primer in a single run. Without this feature, the user would have to conduct successive iterative runs to identify promising candidates if the original selection criteria are too stringent. Further, the user can determine the role different factors play in the formulating the score for the primer by varying the values for the terms that are used to formulate the score.

The following parameters are common to the Gap, Quality and Coverage modes.

| | Parameter Name | Description |
|---|---|---|
| 1) | Expected High Quality | Sets the useable length of a |
| | Read Length | read for improving quality |
| 2) | Templates per Primer | Sets the number of templates |
| | | to be used per primer |
| 3) | Maximum primer distance | Sets the maximum distance of |
| | from region to be | the primer from the |
| | improved | improvement target |
| 4) | Minimum primer distance | Sets the maximum distance of |
| | from region to be | the primer from the |
| | improved | improvement target |
| 5) | Minimum primer length | Sets the minimum length of a |
| | | primer generated by |
| | | PrimerEngine |
| 6) | Maximum primer length | Sets the maximum length of a |
| | | primer generated by |
| | | PrimerEngine |
| 7) | Primer uniqueness to | Sets whether primers should |
| | Project | be searched for uniqueness |
| | | within all contig consensus |
| | | sequences within a project |
| 8) | Ignore template | Sets whether or not the |
| | availability | templates with a value = 0 |
| | | are excluded from primer- |
| | | template reactions |
| 9) | Primer uniqueness in | Sets whether a primer should |
| | template | be searched for uniqueness |
| | | in a template |
| 10) | Number of unique 3′ | Sets the number of bases to |
| | bases | be used in the uniqueness |
| | | searches, whether for |
| | | project uniqueness or |
| | | template uniqueness |
| 11) | Penalize bases with | Sets the threshold phrap |
| | quality below | quality score, scores below |
| | | this value are penalized |

For the Gap mode, the “Primer/Template pair score” is the sum of the “PrimerScore,” “ExternalTemplateScore,” and “PrimerTemplateInteractionScore.”

For the Quality mode, the “Primer/Template pair score” is the sum of the “PrimerScore,” “InternalTemplateScore,” and “PrimerTemplateInteractionScore.”

The parameter “PrimerScore” is the sum of the following parameters,

+[Max(0.0, maximumInternalRepeat−internalRepeatThreshold)*internalRepeatCoefficient]

+[DistanceCoefficient*distanceFromTarget]

+[cumulativeError*cumulativeErrorCoefficient]

+[Max(0, minimumDesiredTm−Tm)*belowMinimumTmCoefficient]

+[Max(0, Tm−maximumDesiredTm)*aboveMaximumTmCoefficient]

+[selfComplementarityCoefficient*bestSelfComplementarityScore]

+[hairpinCoefficient*bestHairpinScore+hasAmbiguousBase*ambiguousBaseCoefficient]

It should be noted that self complementarity and hairpins are measured in terms of H-bonds in the stem; that is, a G-T pair scores 1, a G-C pair scores 3, and an A-T pair scores 2. Stems are quality filtered so that a stem must have an average of 2 bonds/base.

The parameter “ExternalTemplateScore” can be determined according to the following formulas,

[(missingMateHalfTemplateCoefficient*IsMissingMateHalfTemplate]; or

[singletHalfTemplateCoefficient*isSingletHalfTemplate]; or

[externalMateHalfTemplateCoefficient*isExternalMateHalfTemplate]; or

[(externalMateCoefficient*isExternalMate)+(confirmingTemplateCoefficient*numberOfExternalTemplatesToSameContig)]

The parameter “InternalTemplateScore” can be determined according to the following formulas,

[(missingMateHalfTemplateCoefficient*IsMissingMateHalfTemplate]; or

[singletHalfTemplateCoefficient*isSingletHalfTemplate]; or

[externalMateHalfTemplateCoefficient*isExternalMateHalfTemplate]; or

[internalMateCoefficient*isInternalMate]

The parameter “PrimerTemplateInteractionScore” is determined according to the following formula,

ti (TemplateUniquenessCoefficient)*(isPrimer3′EndUniqueToTemplate)+(ProjectUniquenessCoefficient)*(isPrimer3′EndUniqueToProject)

The variable “isPrimer3′EndUniqueToTemplate” and the variable “isPrimer3′EndUniqueToProject” are determined. Setting the variable “TemplateUniquenessCoefficient” to 0.0 will eliminate the template uniqueness search and will speed up PrimerEngine. Similarly, setting the “ProjectUniquenessCoefficient” to 0.0 will eliminate the project uniqueness search. The uniqueness search will ignore any matches at the 3 end less than the matchThreshold.

For example, a sample calculation for picking Primer Template pairs for gaps is as follows. The Primer Score is determined as follows,

Primer Score=

−1*distanceFromTarget

−10000*cumulativeError

−100*Max(0, 40−Tm)

−100*Max(0, Tm 65)

−200*bestSelfComplementarityScore

−200*bestHairpinScore

+0*ambiguousBaseCoefficient

(+5000*hasMissingMateHalfTemplate, or

−5000*hasSingletHalfTemplate, or

−5000*hasExternalMateHalfTemplate, or

−5000*hasInternalMateHalfTemplate, or

+1*hasExternalMate, or

+1*hasInternalMate)

The Template Score is determined as follows,

Template Score=

5000*1 (where the variable “isExternal HalfTemplate”=true)

*5 (where the variable “externalTemplates” is to same contig

The Primer Template Interaction Score is determined as follows,

Primer Template Interaction Score=

−15000*0 (where the primer is unique to Template)

−50000*1 (where the primer is not unique to project)

Gap Mode

In the Gap mode 602, the user enters the following hard limits 602.1 that PrimerEngine will use in selecting Primers.

| | Parameter Definition | Enter |
|---|---|---|
| 1) | Expected high quality read | Desired read length |
| | length | |
| 2) | Templates per primer | Desired number of |
| | | templates |
| 3) | Maximum primer distance from | Desired distance |
| | contig end | |
| 4) | Minimum primer distance from | Desired distance |
| | contig end | |
| 5) | Minimum primer length | Desired length |
| 6) | Maximum primer length | Desired length |
| 7) | Check primer uniqueness in | Select or unselect |
| | project | checking primer |
| | | uniqueness |
| 8) | Check primer uniqueness in | Select or unselect |
| | template | checking primer |
| | | uniqueness |
| 9) | Ignore template availability | Select or unselect |
| | | ignoring template |
| | | availability |
| 10) | Number of unique 3′ bases | Desired number of bases |
| 11) | Penalize bases with quality | Desired quality |
| | below a certain value | |

In Weights designation 602.2, the user enters the following multipliers that are used in scoring when picking primers for gaps.

| | Parameter Definition | Enter |
|---|---|---|
| 1) | Average quality | Desired scoring value |
| 2) | Distance from contig end | Desired scoring value |
| 3) | Low quality base | Desired scoring value |
| 4) | Hairpin | Desired scoring value |
| 5) | Seif-complementarity | Desired scoring value |
| 6) | Below minimum Tm | Desired scoring value |
| 7) | Above maximum Tm | Desired scoring value |
| 8) | Missing mate template | Desired scoring value |
| 9) | Singlet template | Desired scoring value |
| 10) | Internal mate template with | Desired scoring value |
| | mate violation | |
| 11) | Internal mate template, no | Desired scoring value |
| | violation | |
| 12) | External mate template with | Desired scoring value |
| | mate violation | |
| 13) | External mate template, no | Desired scoring value |
| | violation | |
| 14) | Non-ACGT base penalty | Desired scoring value |
| 15) | Primer matches more than once | Desired scoring value |
| | in template | |
| 16) | Primer matches more than once | Desired scoring value |
| | in project | |
| 17) | Confirming template | Desired scoring value |

In Contig Selection mode 602.3, the user selects contigs from which primers for gaps are selected. The user can select contigs individually, and designate a change in primer direction. Contigs that have been selected can also be removed. Optionally, the user can select all the contigs associated with the project. In this mode the user can focus the search by selecting a minimum contig size.

Quality Mode

In Quality mode 604, PrimerEngine searches a target sequence to identify targets that are regions of low quality. As used herein, the term “quality” is defined in terms of Phrap quality, which is defined as 10*log(errorProbability). Thus a phrap score of 40 is an error probability of 0.0001 or 1 base in 10,000; a phrap score of 30 is an error probability of 0.001, or 1 base in 1000, etc. PrimerEngine does its calculations by converting quality scores to error probabilities, averaging the error probabilities, and converting the average error probability back to a phrap score. By setting the quality parameters sufficiently low, it is possible that no low quality targets are found, in this instance no primers will be picked.

PrimerEngine has sets of Quality-Specific and Quality/Coverage Specific Parameter that can be designated.

Quality-Specific Parameters

1) Quality window size: This parameter describes a window of N bases for which the average Quality is evaluated. This window is moved along the sequence and the average quality is computed. This window is tested against the average quality parameter. Extending and merging low quality windows assembles the targets.

2) Improve regions with average quality below: This parameter is the threshold average quality for a region to be considered as low quality.

3) Pool low quality regions closer than: This parameter allows the user to merge small low quality regions that are close into a single target.

4) Ignore low quality regions shorter than: This parameter allows the user to ignore low quality targets that are shorter than this threshold value.

Quality/Coverage Specific Parameters

1) minimum primer binding region at contig end: PrimerEngine assumes that primers must be outside of the target. In the case where the quality or coverage target extends to the end of contig, this sets a minimum size region for primers to be selected which will create reads that extend into the target.

2) interval between primers: This parameter limits the pooling of targets so that the resultant target does not exceed this limit. It should be determined that a target does not exceed the length of the two reads from either side of the target.

In the Quality mode 604, the user can enter hard limits 604.1 for quality picked for gaps according to the following parameters,

| | Parameter Definition | Enter |
|---|---|---|
| 1) | Expected high quality read | Desired read length |
| | length | |
| 2) | Templates per primer | Desired number of |
| | | templates |
| 3) | Maximum primer distance from | Desired length |
| | region to be improved | |
| 4) | Minimum primer distance from | Desired length |
| | region to be improved | |
| 5) | Minimum Primer Length | Desired length |
| 6) | Maximum Primer Length | Desired length |
| 7) | Check Primer Uniqueness in | Select or unselect for |
| | Project | primer uniqueness |
| 8) | Ignore template availability | Select or unselect for |
| | | template uniqueness |
| 9) | Check Primer Uniqueness in | Select or unselect for |
| | Template | primer uniqueness |
| 10) | Number of unique 3′ bases | Desired number of bases |
| 11) | Penalize bases with quality | Desired quality |
| | below | |
| 12) | Quality window size | Desired window size in |
| | | number of bases |
| 13) | Improve regions with average | Desired quality |
| | quality below | |
| 14) | Pool low quality regions | Desired region size in |
| | closer than | number of bases |
| 15) | Ignore low quality regions | Desired region size in |
| | shorter than | number of bases |
| 16) | Minimum primer binding | Desired region size in |
| | region at contig end | number of bases |
| 17) | Interval between primers | Desired interval size |
| | | in number of bases |

In the Quality mode 604, the user can enter desired Weights forms 604.2 that enter multipliers used in the scoring for designating quality for gaps. The available weights forms are as follows.

| | Parameter Definition | Enter |
|---|---|---|
| 1) | Average Quality | Desired scoring value |
| 2) | Distance From low quality | Desired scoring value |
| | region | |
| 3) | Low Quality Base | Desired scoring value |
| 4) | Hairpin | Desired scoring value |
| 5) | Self-complementarity | Desired scoring value |
| 6) | Below Minimum Tm | Desired scoring value |
| 7) | Above Maximum Tm | Desired scoring value |
| 8) | Missing mate template | Desired scoring value |
| 9) | Singlet template | Desired scoring value |
| 10) | Internal mate template with | Desired scoring value |
| | mate violation | |
| 11) | Internal mate template, no | Desired scoring value |
| | violation | |
| 12) | External mate template with | Desired scoring value |
| | mate violation | |
| 13) | External mate template, no | Desired scoring value |
| | violation | |
| 14) | Non-ACGT base penalty | Desired scoring value |
| 15) | Primer matches more than once | Desired scoring value |
| | in template | |
| 16) | Primer matches more than once | Desired scoring value |
| | in project | |
| 17) | Confirming template | Desired scoring value |

In Contig Selection mode 604.3, the user selects contigs from which the user can select for quality for gaps. The user can select contigs individually, and designate a change in the primer start position.

Contigs that have been selected can also be removed. Optionally, the user can select all the contigs associated with the project. In this mode the user can focus the search by selecting a minimum contig size.

Coverage Mode

In Coverage mode 606, PrimerEngine scan the contig for low coverage regions, that is, single stranded regions, and selects these as targets. As used herein, the term “low coverage” refers to a region that has only single stranded coverage. In Coverage mode 606 there are two types of parameters for selecting targets, coverage of specific parameters; and quality/coverage of specific parameters. Coverage of specific parameters includes,

1) Pool low coverage regions closer than: This parameter enables the user to merge small low coverage regions that are close together into a single target.

2) Ignore low coverage regions shorter than: This parameter enables the user to ignore low coverage targets that are shorter than this threshold value.

Quality/coverage of specific parameters includes,

1) minimum primer binding region at contig end: PrimerEngine assumes that primers must be outside of the target. In the case where the quality or coverage target extends to the end of contig, this sets a minimum size region for primers to be selected which will create reads that extend into the target.

2) interval between primers: This parameter limits the pooling of targets so that the resultant target does not exceed this limit because primers are picked only at the ends of the targets. The user should confirm that a target does not exceed the length of the two reads from either side of the target.

In the Coverage mode 606, as in the Gap mode 602 and the Quality mode 604, the user can enter hard limits 606.1 for coverage picked for gaps according to the following parameters,

| | Parameter Definition | Enter |
|---|---|---|
| 1) | Expected high quality read | Desired read length |
| | length | |
| 2) | Templates per primer | Desired number of |
| | | templates |
| 3) | Maximum primer distance from | Desired distance |
| | region to be improved | |
| 4) | Minimum primer distance from | Desired distance |
| | region to be improved | |
| 5) | Minimum Primer Length | Desired length |
| 6) | Maximum Primer Length | Desired length |
| 7) | Check Primer Uniqueness in | Select or unselect |
| | Project | checking primer |
| | | uniqueness |
| 8) | Ignore template availability | Select or unselect |
| | | ignoring template |
| | | availability |
| 9) | Check Primer Uniqueness in | Select or unselect |
| | Template | checking primer |
| | | uniqueness |
| 10) | Number of unique 3′ bases | Desired number of |
| | | bases |
| 11) | Penalize bases with quality | Desired quality |
| | below | |
| 12) | Pool low coverage regions | Desired region size in |
| | closer than | number of bases |
| 13) | Ignore low coverage regions | Desired region size in |
| | shorter than | number of bases |
| 14) | Minimum primer binding region | Desired region size in |
| | at contig end | number of bases |
| 15) | Interval between primers | Desired interval size |
| | | in number of bases |

In the Coverage mode 606, the user can enter desired Weights forms 606.2 that enter multipliers used in the scoring for designating coverage for gaps. The available weights forms are as follows.

| | Parameter Definition | Enter |
|---|---|---|
| 1) | Average Quality | Desired scoring value |
| 2) | Distance From low quality | Desired scoring value |
| | region | |
| 3) | Low Quality Base | Desired scoring value |
| 4) | Hairpin | Desired scoring value |
| 5) | Self-complementarity | Desired scoring value |
| 6) | Below Minimum Tm | Desired scoring value |
| 7) | Above Maximum Tm | Desired scoring value |
| 8) | Missing mate template | Desired scoring value |
| 9) | Singlet template | Desired scoring value |
| 10) | Internal mate template with | Desired scoring value |
| | mate violation | |
| 11) | Internal mate template, no | Desired scoring value |
| | violation | |
| 12) | External mate template with | Desired scoring value |
| | mate violation | |
| 13) | External mate template, no | Desired scoring value |
| | violation | |
| 14) | Non-ACGT base penalty | Desired scoring value |
| 15) | Primer matches more than once | Desired scoring value |
| | in template | |
| 16) | Primer matches more than once | Desired scoring value |
| | in project | |
| 17) | Confirming template | Desired scoring value |

Within these categories, the user further refine the primer selection by specifying uniqueness in weight, quality weight, and length restriction. PrimerEngine provides another benefit to the user by taking into account template quality and availability. Incorporated by reference are the references, Ewing, B. et. al, “Base-Calling of Automated Sequencer Traces Using Phred. I. Accuracy Assessment” 8:175-185, 1998 Genome Research; Ewing, B. et. al, “Base-Calling of Automated Sequencer Traces Using Phred. II. Error Probabilities” 8:186-194, 1998 Genome Research (attached as Appendix C and D, respectively).

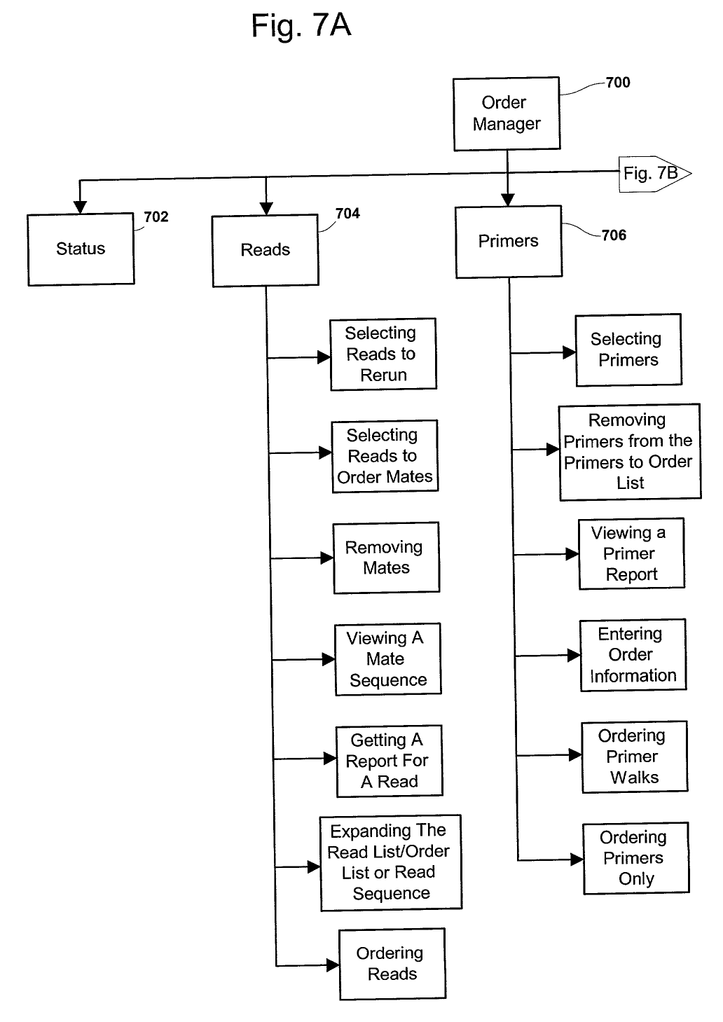

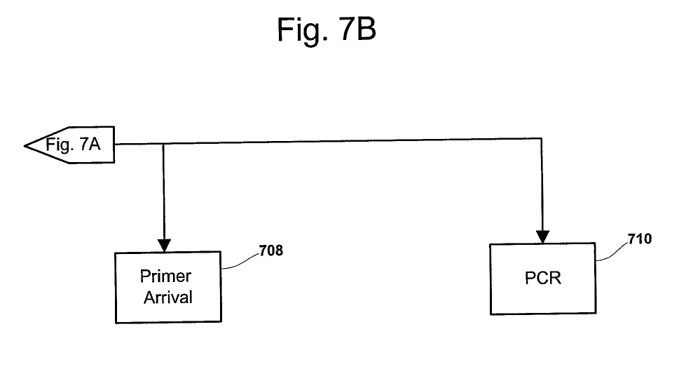

The Order Manager 700 component is depicted in FIGS. 7A and 7B. The component is made up of five sub-components for accessing categories of information, Status 702, Reads 704, Primers 706, Primer Arrival 708 and PCR 710. The component provides an Owner with tracking and monitoring information about the status of any given order or sequencing-reaction. The Order Manager monitors the elements of sequence reaction, such as, templates, primers, plates, and wells, along with reaction attributes such as, chemistry, and reaction type, for example, PCR/shotgun/‘finishing’ primer-walk. Order Manager also manages auxiliary information about each order and each reaction, such as, the identify of the user requesting the order, the project for which the order was submitted, and various clerical information, such as, accounting, charge number, and invoicing information. In the process of creating an order, the Order Manager forwards appropriate information to related systems or entities.

The Order Manger integrates the ordering process by forwarding appropriate information to related systems or entities. For example this includes, forwarding entry information to any laboratory sequence processing management system; in applicable forwarding ordering information to appropriate outside vendors to order custom supplies, and then tracking the status of the order before, during and after the arrival of a custom order; adjusting specific aspects of a given order appropriate for the experiment, such as, ordering primers in individual tubes or entire plates with pre-assigned primer locations, depending on the reaction and accounting protocols. The Order Manager also maintains the history of the processes suitable for providing auditing information.

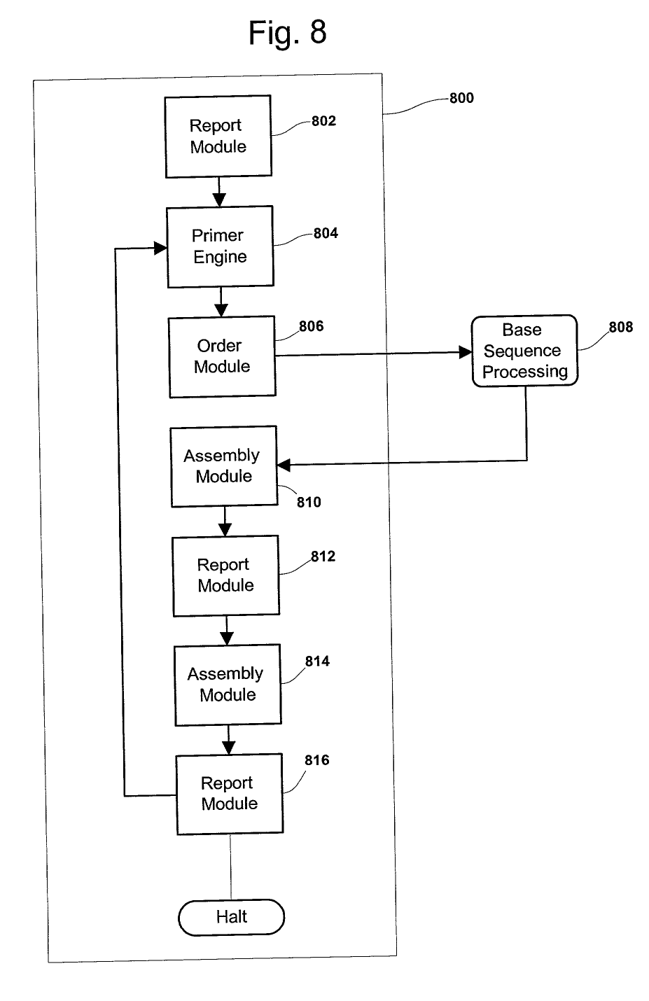

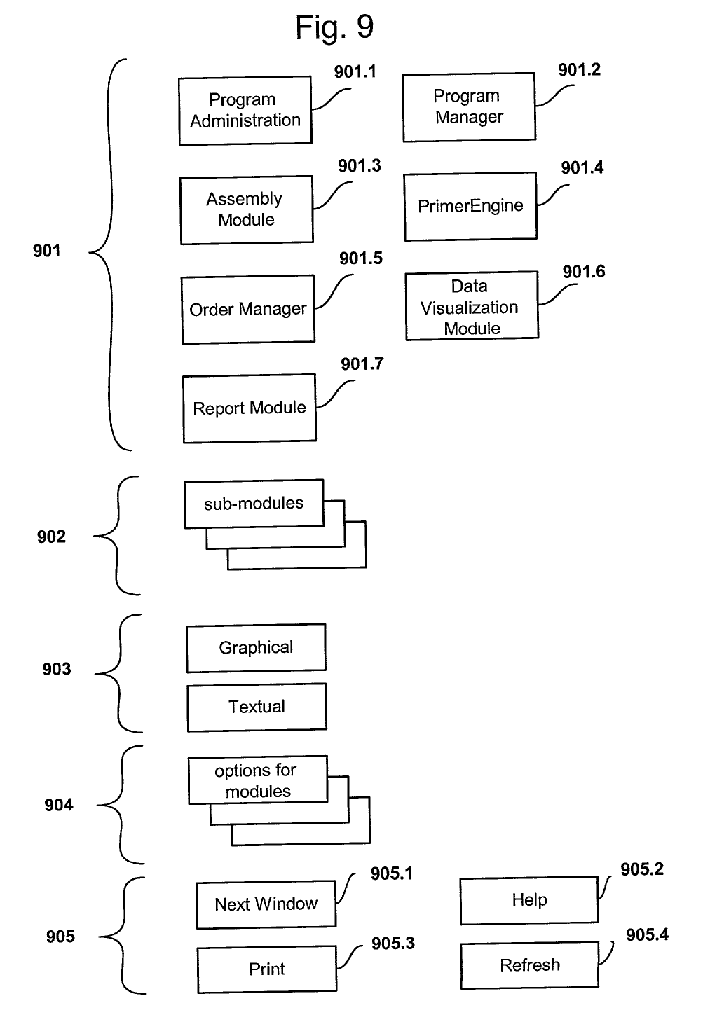

FIG. 8 is a functional block depicting an example assembly process run. The components of the present invention involved in this process is indicated by 800. At 802, a user access the Report Module to determine the quality of an assembly using any or all of the tools available in the Report Module. If an assembly run is desired, the user accesses the PrimerEngine 804 and selects a primer suitable for generating reads needed to complete or enhance the assembly, such as for quality, gaps or coverage. The Order Manager 806 is accessed to request the desired reads and primer-directed reads to be generated, or purchased. The materials are provided to a base sequence processing provider or service 808 that returns the resultant reads to the Assembly module 810. The Assembly module 810 creates an initial assembly for all of the reads in the project. The reads are processed by the Artifact sub-component 812 of the Reports module that removes reads that form contigs with artifacts such as, reads that form contigs with E. coli contamination. The remaining reads are re-processed by the Assembly module 814. The user accesses the Report module 816 to review the quality of the assembly using any or all of the tools available in the Report Module. If desired the user can halt the process at this point. Alternatively, the user can initiate another process by accessing the PrimerEngine 804

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computerized method for managing the finishing of a complete genome, or fragment thereof or a related derivative thereof, comprising:
maintaining a PrimerEngine component for identifying combinations of primers and templates according to suitability for gap closure, quality enhancement or coverage;
maintaining a Project Manager component to identify projects, users and sequence data sources;
controlling an Assembly module to reassemble nucleic acid sequences into artificial chromosomes or genomes; and
accessing a Project Administration component to create projects and to assign user access to the projects.

2. The method of claim 1 wherein said complete genome is an artificial chromosome.

3. A computerized method for managing the finishing of a complete genome, or fragment thereof or a related derivative thereof, comprising:
maintaining a PrimerEngine component for identifying combinations of primers and templates according to suitability for gap closure, quality enhancement or coverage;
maintaining a Project Manager component to identify projects, users and sequence data sources;
controlling an Assembly module to reassemble nucleic acid sequences into artificial chromosomes or genomes;
accessing a Project Administration component to create projects and to assign user access to the projects; and
accessing a Data Visualization Module to provide information about reads, and contigs.

4. The method of claim 3 wherein said complete genome is an artificial chromosome.

5. A computerized method for managing the finishing of a complete genome, or fragment thereof or a related derivative thereof, comprising:
maintaining a PrimerEngine component for identifying combinations of primers and templates according to suitability for gap closure, quality enhancement or coverage;
maintaining a Project Manager component to identify projects, users and sequence data sources;
controlling an Assembly module to reassemble nucleic acid sequences into artificial chromosomes or genomes;
accessing a Project Administration component to create projects and to assign user access to the projects;
accessing a Data Visualization Module to provide information about reads, and contigs; and
accessing a Report module to provide information about a project.

6. The method of claim 5 wherein said complete genome is an artificial chromosome.

7. A computerized method for managing the finishing of an artificial chromosome or genome, comprising:
maintaining a PrimerEngine component for identifying combinations of primers and templates according to suitability for gap closure, quality enhancement or coverage;
maintaining a Project Manager component to identify projects, users and sequence data sources;
controlling an Assembly module to reassemble nucleic acid sequences into artificial chromosomes or genomes;
accessing a Project Administration component to create projects and to assign user access to the projects;
accessing a Data Visualization Module to provide information about reads, and contigs;
accessing a Report module to provide information about a project; and
accessing an Order module to provide information about the status of an order or sequence-reaction.

8. The method of claim 7 wherein said complete genome is an artificial chromosome.

9. A computerized system for managing the finishing of a complete genome, or fragment thereof or a related derivative thereof, comprising:
a primer template database component operative to identify combinations of primers and templates according to suitability for gap closure, quality enhancement or coverage.

10. The method of claim 9 wherein said complete genome is an artificial chromosome.

11. A computerized system for managing the finishing of a complete genome, or fragment thereof or a related derivative thereof, comprising:
a PrimerEngine component operative to identify combinations of primers and templates according to suitability for gap closure, quality enhancement or coverage; and
a Project Manager component operative to identify projects, users, and sequencing data sources.

12. The method of claim 11 wherein said complete genome is an artificial chromosome.

13. A computerized system for managing the finishing of a complete genome, or fragment thereof or a related derivative thereof, comprising:
a PrimerEngine component operative to identify combinations of primers and templates according to suitability for gap closure, quality enhancement or coverage;
a Project Manager component operative to identify projects, users, and sequencing data sources; and
an Assembly module operative by reassembling nucleic acid sequences into artificial chromosomes or genomes.

14. The method of claim 13 wherein said complete genome is an artificial chromosome.

15. A computerized system for managing the finishing of a complete genome, or fragment thereof or a related derivative thereof, comprising:
a PrimerEngine component operative to identify combinations of primers and templates according to suitability for gap closure, quality enhancement or coverage;
a Project Manager component operative to identify projects, users, and sequencing data sources;
an Assembly module operative by reassembling nucleic acid sequences into artificial chromosomes or genomes; and
a Data Visualization Module operative to provide information about reads, and contigs.

16. The method of claim 15 wherein said complete genome is an artificial chromosome.

17. A computerized system for managing the finishing of a complete genome, or fragment thereof or a related derivative thereof, comprising:
a PrimerEngine component operative to identify combinations of primers and templates according to suitability for gap closure, quality enhancement or coverage;
a Project Manager component operative to identify projects, users, and sequencing data sources;
an Assembly module operative by reassembling nucleic acid sequences into artificial chromosomes or genomes;
a Data Visualization Module operative to provide information about reads, and contigs; and
a Report module operative to provide information about a project.

18. The method of claim 17 wherein said complete genome is an artificial chromosome.

19. A computerized system for managing the finishing of a complete genome, or fragment thereof or a related derivative thereof, comprising:
a PrimerEngine component operative to identify combinations of primers and templates according to suitability for gap closure, quality enhancement or coverage;
a Project Manager component operative to identify projects, users, and sequencing data sources;
an Assembly module operative by reassembling nucleic acid sequences into artificial chromosomes or genomes;
a Data Visualization Module operative to provide information about reads, and contigs;
a Report module operative to provide information about a project; and
an Order module operative to provide information about the status of an order or sequence-reaction.

20. The method of claim 19 wherein said complete genome is an artificial chromosome.

21. A computerized system for managing the finishing of a complete genome, or fragment thereof or a related derivative thereof, comprising:
a PrimerEngine component operative to identify combinations of primers and templates according to suitability for gap closure, quality enhancement or coverage;
a Project Manager component operative to identify projects, users, and sequencing data sources;
an Assembly module operative by reassembling nucleic acid sequences into artificial chromosomes or genomes;
a Data Visualization Module operative to provide information about reads, and contigs;
a Report module operative to provide information about a project;
an Order module operative to provide information about the status of an order or sequence-reaction; and
a Project Administration component operative to create projects and to assign user access to the projects.

22. The method of claim 21 wherein said complete genome is an artificial chromosome.
